(19) United States
(12) Patent Application Publication
(10) Pub. No.: US 2003/0024509 A1
(43) Pub. Date: Feb. 6, 2003

(54) Method and apparatus for increasing the delivery of fuel to an engine

(76) Inventors: Steve M. Matusek, Shawnee Mission, KS (US); Daniel W. Jones, Lenexa, KS (US); Shawn Wessol, Parkville, MO (US); Glennon R. Roderique, Lenexa, KS (US)

Correspondence Address: The Law Office of Debra J. Fickler, 12525 Grandview Drive, Huntley, IL, 60142-9501, US

(21) Appl. No.: 10/084,296

(22) Filed: Feb. 25, 2002

Related U.S. Application Data
(60) Provisional application No. 60/270,804, filed on Feb. 23, 2001.

(51) Int. Cl. F02M 37/04

(52) U.S. Cl. 123/497; 123/512

(57) ABSTRACT

An adjustable booster pump and controller is provided for controlling the amount of fuel delivered to an engine. The adjustable booster pump and controller utilize the engine's original fuel input system and may be used to increase the flow of fuel to the engine as a function of fuel demand. Various inputs may be inputted in the controller to determine under what conditions more fuel is needed. These inputs may be time, engine revolutions per minute, vehicle speed, manifold intake pressure, and others. The user may then selectively determine when more fuel is needed and may adjust the controller to increase the output of the booster pump to increase the fuel flow to the engine.

This application claims priority to provisional U.S. Application Ser. No. 60/270,804, filed Feb. 23, 2001.

### FIELD OF THE INVENTION

This invention relates to a method for increasing the volume of fuel delivered to an engine utilizing the existing fuel system and a boosting fuel delivery apparatus. More specifically, the invention may be used to increase the volume and pressure of fuel delivered to the combustion chamber to compensate for sudden changes in demand for fuel such as the increased intake air pressure created by a turbo or supercharger.

### BACKGROUND OF THE INVENTION

The automotive industry has developed various styles of fluid pumps such as simple mechanical piston actuated pumps to complex mechanical or electrical gear or rotor style pumps to deliver fuel from the fuel tank to the engine. A popular fuel system utilized on many gasoline automobiles and trucks includes an electrical fuel pump positioned inside the fuel tank. A pressure regulator is typically utilized to control the fuel pressure and may also be located inside the fuel tank in series with the pump. Power is supplied to the pump via an electrical connect to the battery. The battery is also charged during the running of the engine by an alternator or generator.

The pressure regulator controls the fuel pressure fluctuates due to changing operating conditions. For example, an engine demands more fuel under changing throttle conditions caused by passing or when attempting to make sudden increases in speed. Likewise, during deceleration and idling conditions, the engine's demand for fuel is lower and too much fuel in this situation may wash out the spark, a condition commonly referred to as “flooding” the engine or cylinder. When an engine is flooded, it typically will not start. In the most extreme cases, the spark plugs must be removed from the combustion chamber (cylinder) and either replaced or allowed to dry (fuel will evaporate). Paradoxically, the pressure regulator must be set at a pressure that is high enough to satisfy the engine's demand for fuel during acceleration conditions and low enough to prevent flooding. Automobile manufacturers may use computer models that simulate various operating conditions or use an engine dynamometer to collect operating condition data to determine the proper fuel pressure for the particular size of engine and fuel pump. Also, for in-tank configurations, the fuel regulator must be adjusted to the proper pressure before installation in the fuel tank.

A similar common fuel system configuration utilizes a fuel pump in the fuel tank, however, the fuel pressure regulator is mounted outside of the fuel tank somewhere in the fuel line before the carburetor or fuel injection system. This type of system allows the mechanic to “tune” the fuel pressure to the demands of the engine. Also, the regulator may be easily replaced if it failures to operate correctly or by a more accurate after market fuel pressure regulator. Many of these in-tank fuel pump systems are “return-less” systems. That is, all fuel is delivered to the carburetor or fuel injection system. Whereas, a “return” system provides a return fuel line, typically from the fuel pressure regulator that returns any excess fuel to the fuel tank. A return system allows the pressure regulator to maintain the fuel pressure during peak demands and at times of low demand such as idling or driving at constant speeds which out accelerating without flooding the engine.

Most internal combustions engine applications, the engine's demand for fuel varies with changing input conductions and output demands. For example, an internal combustion engine used to generate electricity requires more fuel as the electrical load (output demand) increases. Likewise, automobile engines require more fuel during acceleration, driving up hills and while transporting heavier items than needed during idling conditions or when traveling at low speeds. Changing environmental conditions may also create different fuel demands on the engine. For example, in humid operating conditions, there are fewer air molecules per volume available to mix with the fuel for combustion than the same volume of air under low humidity conditions. This mixture of fuel and air is commonly referred to as the “charge” that undergoes combustion in the combustion chamber or cylinder. Each cylinder of the engine, which may vary from 1 to 12 cylinders, is the same volume and the sum of the cylinder volumes is referred to the size of the engine such as 440 cubic inches or 5.0 liters.

Modern passenger cars and high performance vehicles including boats and some racecars, utilize fuel injection systems to deliver the fuel to the combustion chamber. The fuel pump and regulator system described earlier is often used to deliver the fuel to a throttle body with a single injector (“single point injection”) or to a series of injectors (“multipoint injection”). Various injector configurations and manifolds are used including rail systems or direct injection into the cylinder with one or more injectors.

Along with the fuel, air is also needed for combustion. The most basic air intake system is a passive system that directs the external air into an intake manifold where fuel is added or injected into the air stream and directed to a particular cylinder. On the other hand, active air intake systems require an additional component that actively draws in air from the atmosphere or alternatively, draws in the waste product of combustion, commonly referred to as exhaust.

Fuel injection systems also vary in complexity. For example, one fuel injection system may use one injector per cylinder and locate the injector in the particular pipe or track of the intake that feeds the cylinder. Conversely, complex physical configuration are also utilized, consisting of multiple injectors per cylinder that inject the fuel directly in the cylinder chamber or are positioned in each intake manifold pipe or track that feeds the cylinder. Likewise, an electronic control unit (ECU) is utilized to provide the electrical impulses that cause the injector to open and close for a conditional or predetermined length of time. Moreover, the complexity of the ECU also varies by the engine and application.

The ECU of a simple fuel injection systems may utilize a single engine condition such as RPM, to reference a “look-up” table stored in memory of the system that contains the length of time to keep an injector open at that particular engine condition such as intake manifold absolute pressure, “MAP,” or revolutions per minute, “RPM,” of the engine. This “length of time” is often referred to as “pulse width.” More complex systems may use complex algorithms to determine the injector pulse width based upon multiple engine conditions such as MAP, RPM, engine temperature, intake air temperature and others other factors. These multiple engine conditions are monitored by the ECU, which computes the pulse width of each fuel injectors in an attempt to reach the most efficient, burning air-fuel ratio called the stoichiometric ratio.

One limitation of these types of injection systems is that the automobile manufacturer programs the ECU and someone affiliated with the manufacturer must make any changes to the system. Some aftermarket companies have developed replacement microchips that contain new programs or unique look-up tables for various applications such as increased performance or power, high altitude driving conditions, cold environmental applications, or towing applications. However, these aftermarket replacement systems are not available for the many different fuel injection systems use in automobiles, and likewise, may not be available for the user's particular application.

Another method of delivering fuel and air to the combustion chambers of an engine is with the use of a carburetor, which was more commonly used by automobile manufacturers in the United States before the 1980's. Like fuel injection, carburetors also vary in complexity. A single jet carburetor is analogous to the single fuel injector system. The carburetor intakes air and releases a metered amount of fuel into the air stream by the jet. Albeit adequate, a single jet carburetor cannot respond to changing engine conditions such as acceleration and deceleration, cold starting condition and changing load conditions on the engine. To satisfy these conditions, various carburetor configurations have been developed such a multiple jets that are activated when larger amounts of fuel are need, multiple venturi to increase the velocity of the air as it travels through the carburetor and accelerator pumps to quickly deliver fuel under acceleration conditions. Carburetors are also used with electronic fuel pumps and mechanical fuel pumps. Often, the electrical fuel pump is located inside the fuel tank. As stated above, a fuel pressure regulator is used to control the fuel pressure and may be located inside the tank near the fuel pump or outside the tank near the carburetor. One limitation of an even the most complex carburetor system, is that it can only deliver as much fuel as it receives from the fuel pump.

Besides passenger automobiles, carburetors are also used in high performance applications such as racecars, racing boats and motorcycles; stockcars raced in the United States typically use carburetors as well as drag racing and street rods applications. Many drag racing vehicles are modified stock passenger cars that have been equipped with roll cages, safety harnesses, widow nets, racing tires or “slicks,” and minor modifications to the engines such as a high performance ignition systems and racing transmission. Likewise, these former “stock” cars typically have all unnecessary components removed to decrease weight, such as the stock exhaust and mufflers, radios, electrical harnesses for electrical windows, door locks, trunk release, interior and some exterior lights. Conversely, the racer may choice to use the original fuel system or the rules of the sanctioning body may require the use of particular original equipment manufactured, “OEM,” such as the fuel tank. This rule may put a racer with the fuel pump in the tank at a disadvantage because the engine is limited by the output of the OEM fuel pump.

One method of increasing the acceleration and speed of both fuel injection and carbureted engines is by the addition of a turbo or supercharger. A supercharger is used to increase the density of the either the air or the air-fuel mixture before it is delivered to the combustion chamber or cylinder. This allows more oxygen to enter the cylinder for combustion and thereby, increasing the efficiency of the burnt mixture which, in turn, raises the power output of the engine. The supercharger actively draws in air and compresses it before or after fuel is injected into the intake air. Even a few pounds (per square inch) increase of pressure in the air-fuel mixture, or charge, in the cylinder can result in faster rates of acceleration and more efficient combustion, which may be closer to stoichiometric burn.

Various types of superchargers have been developed for automotive use with both conventional fuel engines and diesel engines. These include the sliding vane supercharger, the Shorrock or semi-articulating sliding vane supercharger, various styles of roots supercharges with clutches and bypass valves that engages the supercharger only under high loads and speeds, screw superchargers, and centrifugal superchargers. The last style, the centrifugal supercharger, can be easily added to a non-supercharged engine without much modification as long as there is room in the engine compartment of the unit.

Another method for increasing power output of an engine is by adding a turbocharger to the engine, which can be added to either a fuel injection or carburetor system. A turbocharger utilizes the waste product of combustion, the exhaust. The air-fuel charge is released into the cylinder via an intake valve that opens while the piston is traveling downward in the cylinder. As the piston in the cylinder reverses directions and travels upward, the piston compresses the charge and somewhere near the top of this upstroke, a spark plug (in gasoline engines) sparks and ignites the charge. (Diesel engines, which relay on temperature and compression to ignite the charge, often utilize turbochargers. The exhaust not only compresses the air-diesel charge but also increase the charge temperature closer to the flash point of the mixture.) This explosion drives the piston downward in the cylinder and provides the power to rotate the crankshaft. The burnt charge is then expelled out of the cylinder at the end of the power stroke as the exhaust valve opens. The turbocharger receives a portion or all of the exhaust, which, in turn, drives a turbine wheel that propels the centrifugal compressor wheel of the turbocharger. The compressor is then used to increase the pressure of the air-fuel charge that enters the cylinder. One limitation of this type of system is that at lower exhaust pressures, such as idling or at low speeds, the pressure of the exhaust is typically too low to drive the turbine. Thus, a time lag, “turbo lag,” is often experienced during attempts to quick accelerate at lower engine speeds or from a standing start.

A limitation of adding a super or turbocharger to an engine that utilize an OEM fuel system that incorporates an electric fuel pump in the tank, is that when the super or turbochargers increases the demand for fuel when the super or turbo-charger engages. Under these conditions, the fuel pump and regulator of the system attempt to provide a constant predetermined fuel pressure. However, this charge delivered to the cylinder is typically under fueled during these super or turbo-charged conditions due to the increased air volume and pressure and thereby producing power outputs which are lower than the potential of the system.

Therefore, a system is needed to compensate for periods of increased fuel demand. Likewise, the fuel demand is not constant in these dynamic systems. As the charge pressure increases, more fuel can be added to increase efficiency and rate of acceleration. A variable system, which can increase the delivery of the fuel to an engine, is desired. A system is also desired which can be used to gradually increase the volume of fuel to the engine during accelerating from a stopped position with the engine idling, such as the conditions at the starting line of an automobile or boat drag race. Moreover, a system or apparatus which does not add significant amount of weight to the engine, one that can be easily installed and simplistic to use, and one that does not require re-programming of high tech fuel injections systems and engine ECU's is also desired.

### BRIEF SUMMARY OF THE INVENTION

The disclosed method and apparatus provides a system for increasing the amount of fuel delivered to a fuel injection unit or carburetor during conditions of increased demand. For example, the disclosed system provides a variable method of increasing the pressure of fuel delivered by utilizing the existing fuel delivery system, fuel pump and pressure regulator. Furthermore, the present invention requires only minimal additional components that can be easily adapted to an existing engine configuration and for use with return-less style fuel systems. Another important objective of the present method and apparatus is to provide a user controllable system wherein the user can control or use other engine output conditions to control the timing and delivery of the additional fuel as needed to increase engine power output, especially under acceleration conditions such as the start of a drag race.

In accordance with these objections and limitations, the disclosed method and apparatus provides an user adjustable system that can be added to an existing fuel system without removing the original fuel pump or pressure regulation. A booster pump is provided that can be added to the existing fuel line that directs fuel from the fuel tank whether the fuel pump is located in or outside the fuel tank. The booster pump assists the existing or original pump to increase the pressure and therefore the volume of fuel provided to the engine.

A controller is utilized to control the output of the booster pump along with a directional valve. The controller may receive user-inputted values to control the booster pump or may be used in conjunction with output or input conditions of the engine. For example, the user may use the controller to gradually increase the voltage over time delivered to the booster pump. As the voltage increase the speed of the pump increase thereby increase the volume output of the booster pump. Alternatively, the controller may receive an input signal from a sensor such as one that measures throttle positions such that as the throttle opens wider, the voltage delivered to power the booster pump increases as throttle position increases. These and other input or engine output conditions might be used to control the booster pump to increase the power out of the engine.

Other aspects and advantages of the present method and apparatus will be apparent from the following detailed description of embodiments and drawing figures herein.

### BRIEF DESCRIPTION OF THE DRAWINGS

The embodiments of the method and apparatus are described in detail below with reference to the attached drawing figures, wherein:

FIG. 1 is a schematic representation an internal combustion engine and a retum-less fuel system;

FIG. 2 is a schematic representing an internal combustion engine, return-less fuel system and a booster pump and controller;

FIG. 3 is a schematic representation of a controller for a booster pump and a graphic representation of increased pressure of fuel delivery;

FIG. 4 is a schematic drawing of the internal components for a booster pump controller;

FIG. 5 is a schematic drawing of the electrical outputs of the booster pump controller; and

FIG. 6 is a schematic representation illustrating the electrical components of the booster pump controller.

### DETAILED DESCRIPTION OF THE INVENTION

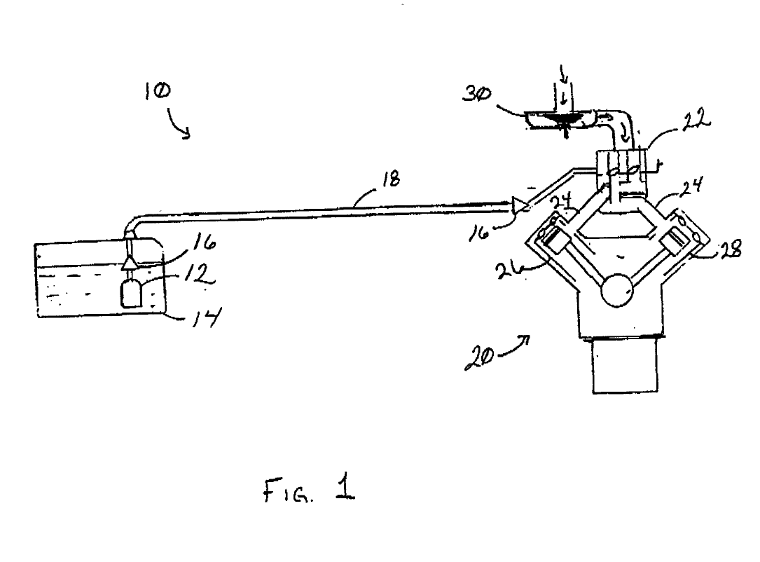

A typical retum-less fuel system 10 is illustrated in FIG. 1 which contains an electrical fuel pump 12 located in the fuel tank 14 with a pressure regulator 16 also located fuel tank 14. Alternatively, pressure regulator 16 may be positioned down stream of fuel pump 12 in a fuel line 18. An engine 20 with a carburetor 22 and intake manifold pipes 24 provide the air-fuel charge to cylinders 26 and 28. A supercharger 30 is utilized to increase the air density before it enters carburetor 22. Alternatively, a turbocharger may replace supercharger 30 and a fuel injection system may replace carburetor 22.

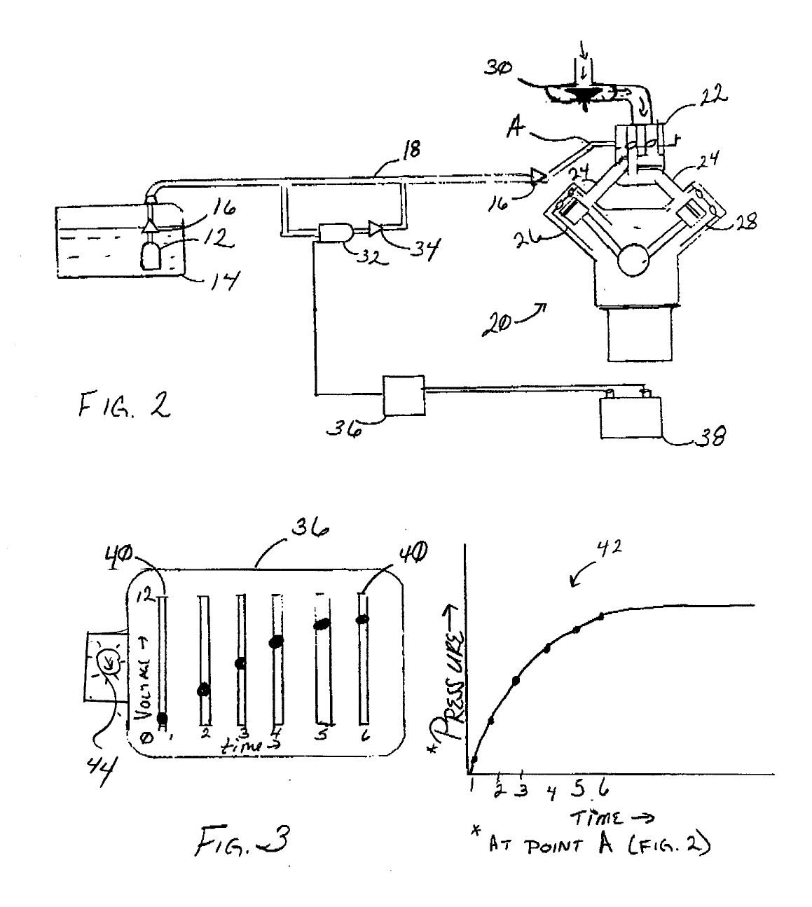

Turning to FIG. 2, a booster pump 32 and booster pressure regulator 34 has been added to fuel line 18. To control booster pump 32, an electronic booster controller 36 is added to the system. A standard 12 volt or 16 volt battery 38 powers electronic booster controller 36. Battery 38 also supplies power to intank fuel pump 12.

Electronic booster controller 36 may have many forms and multiple inputs such as the output parameters of the engine. FIG. 3 illustrates one of the most simplistic versions of electronic booster controller 36. Booster controller 36 has multiple adjustable switches 40 that represent the voltage applied to booster pump 32. Likewise, each switch represents a unit of time such as milliseconds, microseconds, or other time period. When controller 36 powers booster pump 32, the fuel pressure increase from the action of the combined system at location A (see FIG. 2) and is shown in the graph of FIG. 3. An electrical impulse is typically used to signal controller 32 to begin to count time. This impulse may be from a toggle switch activated by the driver, an impulse from the transmission such as the switching of a gear, or the loss in voltage to a transmission brake used on the starting line of a drag race. Therefore, the booster pump 32 and controller 36 allows a user to increase the fuel pressure thereby increasing the volume of fuel delivered to engine 20 for combustion without replacing the original fuel system.

Alternatively, controller 36 may utilize operational inputs from engine 20, such as manifold air pressure or “MAP”, engine revolutions per minute or “RPM”, speed of the vehicle, as well as time. As seen in FIG. 3, these alternative inputs replace the “time” indicia on controller 36 and graph 42. When utilizing engine RPM, the operator sets the adjustable switches 40 to increase the voltage supplied to booster pump 32 to increase the fuel pressure at that particular RPM. To provide a larger scale of RPM ranges, controller 36 may include a rotary dial 44) that provides the user with a multiplication factor for each adjustable switch 40.

For example, the operator may set the first adjustable switch 40 for idling conditions at 2,000 RPM. When using controller 36 with five adjustable switches 40, if the engine's highest operational RPM is 10,000 RPM, each switch would be adjustable in 1,000-RPM increments. However, controller 36 can also be used to control the pressure from booster pump 32 in smaller increments by utilizing rotary dial 44. With rotary dial 44 the range of one adjustable switch 40 may be in 10-RPM increments whereas the next switch may be in 20 to 100 RPM increments. Rotary dial 44 may be calibrated in various multiplication factors such as 2, 5, 10, 20, 50, 100, etc.

Controller 36 may also use the engine intake manifold pressure, MAP, as the operational input to controller 36. This is particularly useful for engines, which utilize electronic fuel injector or those, which are super or turbo-charged. In this application, adjustable switches 40 would represent pressure and controller 36 would increase the supply of fuel to engine 20 as the MAP pressure increases. As stated above, rotary dial 44 may also be used to independently set the particular multiplication factor for each adjustable switch 40.

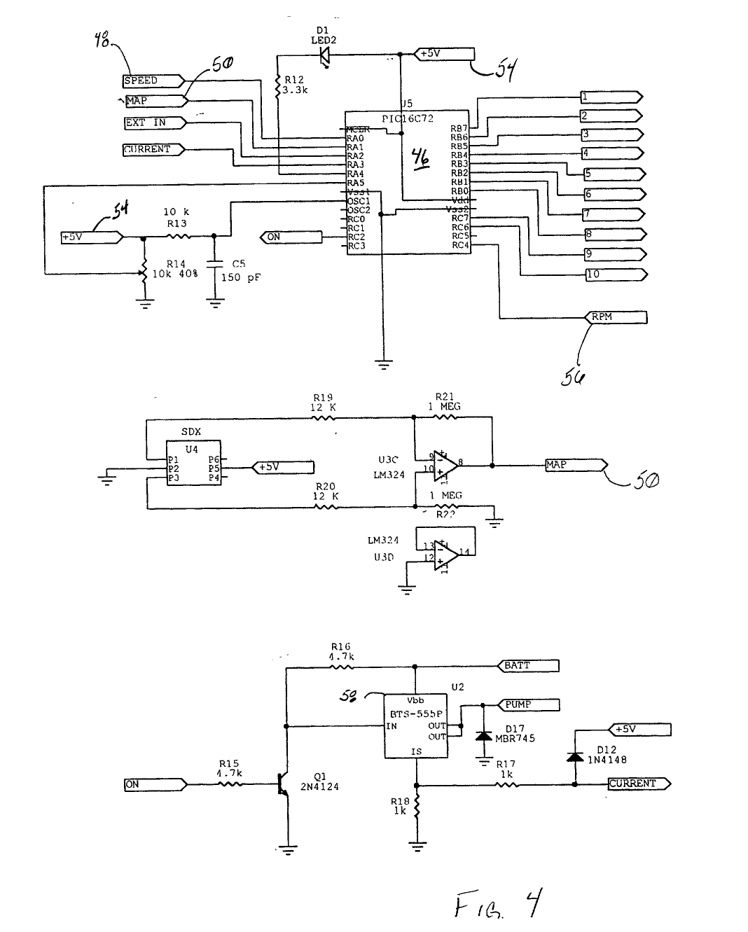

Turning to FIG. 4, controller 36 utilizes a microcontroller 46. In one application a MicroChip CMOS 16C72 microcontroller was used. Microcontroller 46 receives inputs from engine 20 which are supplied as voltage inputs. Microcontroller 46 receives the speed of the vehicle at a speed input 48 at pin RA0 that may be the electrical signal from the speedometer of a vehicle. Likewise, microcontroller 46 receives a MAP sensor input 50 of the at pin RA2. The booster pump current 52 from booster pump 32 is inputted into microcontroller 46 at pin RA3. Microcontroller 46 receives a +5 volt input 54 and a 3.3 k-ohm resister R12 to power microcontroller 46 at pin RA4. A light emitting diode D1 is placed before pin RA3 to signal the user that the unit has power. Microcontroller 46 also receives an RPM input 56 from the engine at pin RC4. Pin RA5 of microcontroller 46 is used for current feedback and is compared to an input voltage from the +5V input 54 through 10 k ohm resister R13 and R14 and 150-picofarad capacitor C5 at pin OSC1. Microcontroller 46 provides ten outs, which will be further described below.

The signal from the MAP sensor (not shown) is first compared to the reference voltage before inputting to microcontroller 46 at pin RA1. A pair of bi-polar voltage comparators, U3C and U3D are used along with integrated circuit U4. FIG. 4 also illustrates integrated circuit 58, which utilizes a transistor Q1 to act to provide the inputs of battery 38 and booster pump 32. Also included in the circuit are diodes D17 that is clamped to ground to prevent reverse current flow to booster pump 32 and diode D12.

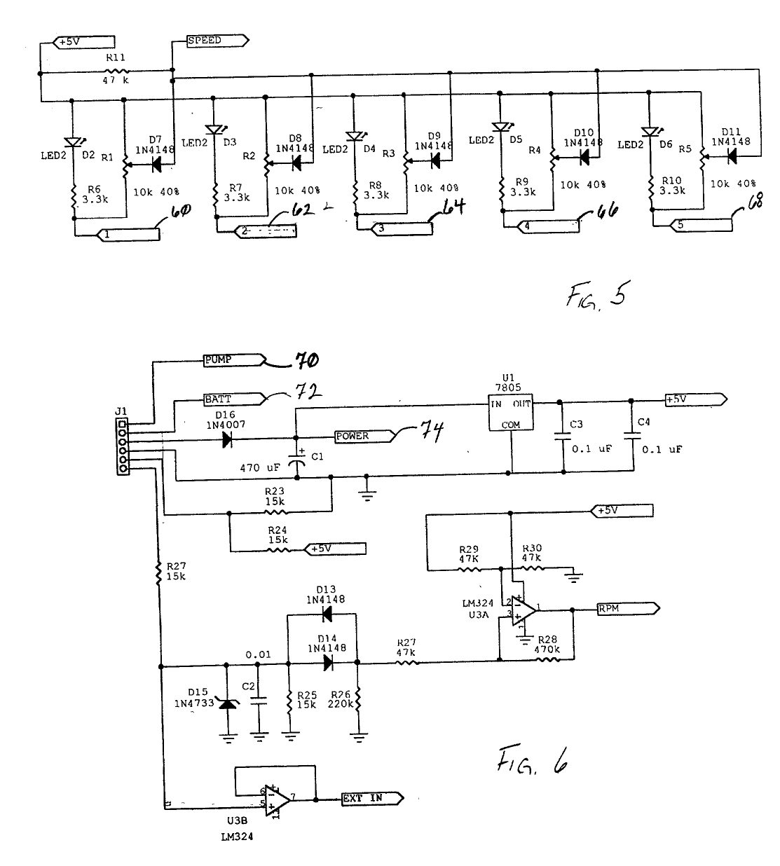

Turning to FIG. 5, a series of diodes and light emitting diodes are coupled to each adjustable switch 40. For the first adjustable switch 60, light emitting diode D2 is used in conjunction with a 3.3 kilo-ohm resistor R6 and 10 kilo-ohm resistor R1 with diode D7. Similarly, adjustable switches 62 through 68 utilize the same corresponding components.

Turning to FIG. 6, jumper J1 acts as the connection between the circuits described above and directs the current for pump output 70, battery output 72 and power output 74 through diode D16 and a 470 microfarad capacitor C1 which is reference in voltage comparator U1 along with 0.1 microfarad, parallel capacitors C3 and C4. Jumper J1 is also used to condition the input signal from the RPM measuring sensor such as a tachometer, to RPM input 56. The RPM signal is compared to the +5V input signal 54 utilizing resistors R29 and R30 which are clamped to ground and a bi=polar voltage comparator U3A. The resulting output of the bi-polar voltage comparator U3A provides the RPM input 56 to microcontroller 46. Zenor diode D15, capacitor C2, resistors R25 and R26 also condition the positive input of bi-polar voltage comparator U3A with parallel opposing diodes D13 and D14.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method for selectively increasing the delivery of fuel to an internal combustion engine, the method including:
increasing the fuel pressure using a pump device;
controlling the output of the pump device; and
delivering the fuel via the pumping device to a fuel delivery device.

2. The method of claim 1 wherein increasing the fuel pressure using a pump device includes sensing a voltage input.

3. The method of claim 2 wherein the step of sensing a voltage input includes receiving an engine operational voltage output.

4. The method of claim 3 wherein the receiving an engine operational voltage output include receiving an output signal representing time, engine revolutions per minute, intake manifold pressure, or vehicle speed.

5. The method of claim 1 wherein controlling the output of the pump device includes increasing a voltage to the pump device.

6. The method of claim 5 wherein increasing a voltage to the pump device creates an increase fuel output of the pump device.

7. The method of claim 6 wherein increasing the fuel output of the pump device includes increasing the delivery of fuel to an engine.

8. An apparatus for selectively increasing the amount of fuel delivered to an internal combustion engine, the apparatus comprising:
a first connection for receiving fuel from a fuel line;
a booster pump for moving fuel;
an electronic controller for controlling the booster pump; and
a second connection for returning the fuel moved by the booster pump to a fuel delivery device.

9. The apparatus of claim 8 wherein the booster pump for moving fuel is an electric pump.

10. The apparatus of claim 8 wherein the electronic controller receives engine operational inputs from the internal combustion engine in the form of a current inputs.

11. The apparatus of claim 10 wherein the current inputs are of the type representing time, engine revolutions per minute, intake manifold pressure, or vehicle speed.

12. The apparatus of claim 10 wherein the electronic controller includes adjustable switches for selectively indicating when the electronic controller will control the booster pump.

13. The apparatus of claim 12 wherein the adjustable switches increase an input voltage to the booster pump.
